(19) United States
(12) Patent Application Publication
(10) Pub. No.: US 2023/0224550 A1
(43) Pub. Date: Jul. 13, 2023

(54) SERVER APPARATUS, TERMINAL APPARATUS, INFORMATION PROCESSING SYSTEM, AND INFORMATION PROCESSING METHOD

(71) Applicant: SONY GROUP CORPORATION, Tokto (JP)

(72) Inventor: Satoshi SUZUKI, Tokyo (JP)

(73) Assignee: SONY GROUP CORPORATION, Tokyo (JP)

(21) Appl. No.: 18/009,861

(22) PCT Filed: Jun. 8, 2021
(86) PCT No.: PCT/JP2021/021715

§ 371 Date: Dec. 12, 2022

(30) Foreign Application Priority Data
Jun. 19, 2020 (JP) 2020-106460

(51) Int. Cl. H04N 21/6405; H04N 21/218; H04N 21/81

(52) U.S. Cl. CPC H04N 21/6405; H04N 21/21805; H04N 21/816

(57) ABSTRACT

There is provided a technology capable of reducing the processing load on a server apparatus side in cloud rendering. A server apparatus according to the present technology includes a controller. The controller groups terminal apparatuses each having a viewing position within an identical segment on the basis of viewing position information of each terminal apparatus within a viewing region including a plurality of segments, and transmits common video information to each of the grouped terminal apparatuses by multicasting.

### TECHNICAL FIELD

The present technology relates to a technology of a server apparatus that performs cloud rendering, and the like.

### BACKGROUND ART

In recent years, an increased network band, an improvement in performance of GPUs, and the like have made it possible to generate three-dimensional videos from videos captured by many cameras and to distribute those videos as free-viewpoint videos. For example, this has made it possible to distribute free-viewpoint videos in sports, music events, and the like, thus providing a user with a viewing experience of enjoying a video from a free viewing position in a free viewing direction.

Conventionally, in distributing high image-quality free-viewpoint videos for providing viewing experiences at free viewpoints, the amount of data has been increased and a large network band has been required accordingly. Further, in order to render a free-viewpoint video, a high-performance GPU or the like has been required for the user's terminal apparatus.

To cope with such problems, cloud rendering is proposed, in which the server apparatus side performs rendering. In the cloud rendering, first, a terminal apparatus transmits information such as a viewing position and a viewing direction to the server. The server apparatus renders a requested video from a free-viewpoint video in response to the received viewing position and viewing direction, encodes this video as a two-dimensional video stream, and then transmits it to the terminal apparatus.

In the cloud rendering, the terminal apparatus only needs to decode and display the two-dimensional video stream, and can thus provide a high image-quality viewing experience to the user even when the terminal apparatus does not include high-performance GPUs or the like.

Note that the technologies relating to the present application include Patent Literature 1 mentioned below.

### CITATION LIST

### Patent Literature

Patent Literature 1: Japanese Patent Application Laid-open No. 2017-188649

### DISCLOSURE OF INVENTION

### Technical Problem

In the cloud rendering, there is a problem that the processing load on the server apparatus side increases in proportion to the number of terminal apparatuses that request viewing.

In view of the circumstances as described above, it is an object of the present technology to provide a technology capable of reducing the processing load on the server apparatus side in cloud rendering.

### Solution to Problem

A server apparatus according to the present technology includes a controller. The controller groups terminal apparatuses each having a viewing position within an identical segment on the basis of viewing position information of each terminal apparatus within a viewing region including a plurality of segments, and transmits common video information to each of the grouped terminal apparatuses by multicasting.

This makes it possible to reduce the processing load on the server apparatus side in cloud rendering.

A terminal apparatus according to the present technology includes a controller.

The controller receives common video information from a server apparatus that groups terminal apparatuses each having a viewing position within an identical segment on the basis of viewing position information of each terminal apparatus within a viewing region including a plurality of segments and transmits the common video information to each of the grouped terminal apparatuses by multicasting, and renders an image to be displayed on the basis of the received common video information.

An information processing system according to the present technology includes a server apparatus and a terminal apparatus.

The server apparatus groups terminal apparatuses each having a viewing position within an identical segment on the basis of viewing position information of each terminal apparatus within a viewing region including a plurality of segments, and transmits common video information to each of the grouped terminal apparatuses by multicasting.

The terminal apparatus receives the common video information and renders an image to be displayed on the basis of the received common video information.

An information processing method according to the present technology includes: grouping terminal apparatuses each having a viewing position within an identical segment on the basis of viewing position information of each terminal apparatus within a viewing region including a plurality of segments; and transmitting common video information to each of the grouped terminal apparatuses by multicasting.

### BRIEF DESCRIPTION OF DRAWINGS

FIG. 1 is a diagram showing an information processing system according to a first embodiment of the present technology.

FIG. 2 is a block diagram showing an internal configuration of a terminal apparatus.

FIG. 3 is a block diagram showing an internal configuration of a management server.

FIG. 4 is a block diagram showing an internal configuration of a distribution server.

FIG. 5 is a diagram showing an example of a viewing region and segments.

FIG. 6 is a diagram showing viewing position information transmission processing in the terminal apparatus.

FIG. 7 is a diagram showing an example of a state where a user is changing a viewing position.

FIG. 8 is a flowchart showing grouping processing and the like in the management server.

FIG. 9 is a diagram showing the relationship between the distribution of the number of terminal apparatuses in each segment and a threshold.

FIG. 10 is a diagram showing an example of a distribution server list.

FIG. 11 is a flowchart showing video information request processing and the like in the terminal apparatus.

FIG. 12 is a flowchart showing video information generation processing and the like in the server apparatus.

FIG. 13 is a flowchart showing small-data-size three-dimensional video generation processing and the like in the management server.

FIG. 14 is a flowchart showing image display processing and the like in the grouped terminal apparatus.

FIG. 15 is a flowchart showing image display processing and the like in the terminal apparatus not grouped.

FIG. 16 is a diagram showing a state where an image is rendered from common video information.

FIG. 17 is a diagram showing a state where the viewing position is moved to a requested viewing position, and a viewing direction is changed to a requested viewing direction.

### MODE(S) FOR CARRYING OUT THE INVENTION

Hereinafter, embodiments according to the present technology will be described with reference to the drawings.

### FIRST EMBODIMENT

### Overall Configuration and Configuration of Each Unit

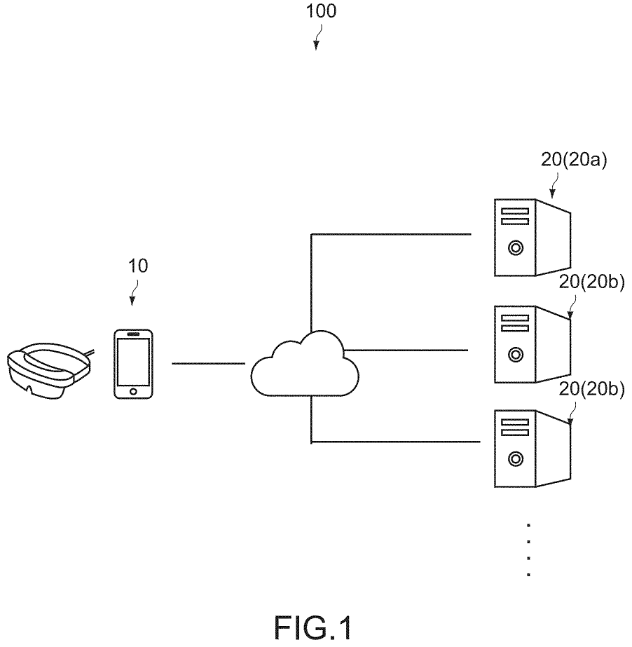

FIG. 1 is a diagram showing an information processing system 100 according to a first embodiment of the present technology. As shown in FIG. 1, the information processing system 100 includes a plurality of terminal apparatuses 10 and a plurality of server apparatuses 20.

The terminal apparatus 10 may be a mobile terminal that can be carried by a user or may be a wearable terminal that can be worn by a user. Alternatively, the terminal apparatus 10 may be a stationary terminal that is installed to be used.

Examples of the mobile terminal include a mobile phone (including a smartphone), a tablet personal computer (PC), a portable gaming machine, and a portable music player. Examples of the wearable terminal include head-mounted-type (head mounted display: HMD), wristband-type (clock-type), pendant-type, and ring-type wearable terminals. Further, examples of the stationary terminal include a desktop PC, a television apparatus, and a stationary gaming machine.

The information processing system 100 in this embodiment is used as a system in which the server apparatus 20 side generates, by cloud rendering, necessary video information from three-dimensional videos corresponding to the whole of an actual event venue (e.g., stadium) or the like in a real space, and a live distribution of the video information to the terminal apparatuses 10 is performed.

Further, the information processing system 100 in this embodiment is used as a system in which the server apparatus 20 side generates, by cloud rendering, necessary video information from three-dimensional videos corresponding to the whole of a virtual event venue (e.g., virtual stadium of a game) or the like in a virtual space, and a live distribution of the video information to the terminal apparatuses 10 is performed.

The user can enjoy a live event held in a real space or a live event held in a virtual space by the user's own terminal apparatus 10. In this case, because of the cloud rendering, the user can enjoy a high-quality video even if the processing capability of the terminal apparatus 10 is low.

If the event or the like is an event in the real space, the user may carry or wear the terminal apparatus 10 and may be at the real event venue or the like (if the terminal apparatus 10 is a mobile terminal or wearable terminal). Alternatively, in this case, the user may be at any place other than the event venue, such as the user's home (regardless of the type of the terminal apparatus 10).

Further, if the event or the like is an event in the virtual space, the user may be present at any place such as the user's home (regardless of the type of the terminal apparatus 10).

Here, it is assumed that the server apparatus 20 side generates individual video information for each terminal apparatus 10 in accordance with a viewing position, a viewing direction, or the like individually requested by each terminal apparatus 10, and transmits all of the individual video information by unicasting. In this case, the processing load on the server apparatus 20 side increases in proportion to the number of terminal apparatuses 10 that request viewing.

For that reason, in this embodiment, the server apparatus 20 side executes the following processing under predetermined conditions: on the basis of the viewing position information of each terminal apparatus 10 within a viewing region 1 including a plurality of segments 2, the terminal apparatuses 10 each having a viewing position in the same segment 2 are grouped; and common video information is transmitted to the grouped terminal apparatuses 10 by multicasting.

Note that the server apparatus 20 side transmits individual video information to the terminals not grouped by unicasting.

FIG. 5 is a diagram showing an example of the viewing region 1 and the segments 2. The example shown in FIG. 5 shows a state where the region corresponding to the whole of a soccer stadium is assumed as the viewing region 1, and the viewing region 1 is divided into the plurality of segments 2. The example shown in FIG. 5 shows a case where the viewing region 1 is divided into 36 segments 2, which are 6×6 segments in the X-axis direction by the Y-axis direction (horizontal direction). Note that the number of segments is not particularly limited. Further, the viewing region 1 may be divided in the Z-axis direction (height direction) to set the segments 2.

In the description of this embodiment, the “viewing region 1” means a region corresponding to an actual event venue or the like in the real space or a virtual event venue or the like in the virtual space, and a region whose video can be viewed (a region in which a viewing position can be set). Further, the “segment 2” means a given region that partitions the viewing region 1.

Further, in the description of this embodiment, the “viewing position” means the base of a viewpoint within the viewing region 1 (indicated by a circle in FIG. 5). The viewing position is a position requested from the terminal apparatus 10 side and is a position within the viewing region 1, which can be optionally set by the user. This viewing position may be a position of the terminal apparatus 10 in the actual event venue if the event is an event in the real space and the terminal apparatus 10 is located in the actual event venue.

Further, in the description of this embodiment, the “viewing direction” means a direction of viewing from the viewing position. The viewing direction is a direction requested from the terminal apparatus 10 side and is a direction that can be optionally set by the user. This viewing direction may be a direction (direction of posture) in which the terminal apparatus 10 (user) faces in the actual event venue if the terminal apparatus 10 is located in the actual event venue.

Note that if the event is an event in the real space, three-dimensional videos corresponding to the whole of the event venue or the like (corresponding to all viewing positions within the viewing region 1) are generated by synthesizing the video information from many cameras installed in the event venue.

Meanwhile, if the event is an event in the virtual space, three-dimensional videos corresponding to the whole of the event venue or the like (corresponding to all viewing positions within the viewing region 1) are generated in advance by the host of the event or the like to be stored in the server apparatus 20 side.

[Terminal Apparatus 10]

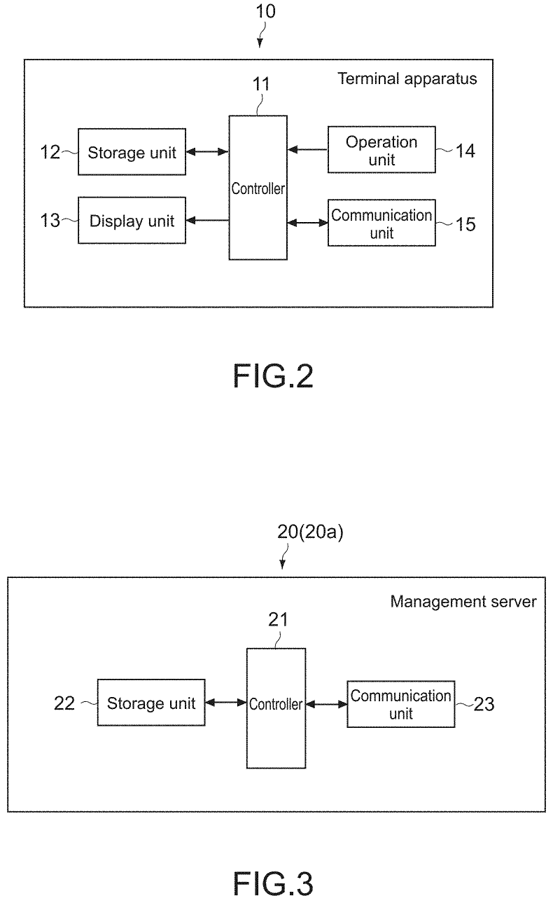

FIG. 2 is a block diagram showing the internal configuration of the terminal apparatus 10. As shown in FIG. 2, the terminal apparatus 10 includes a controller 11, a storage unit 12, a display unit 13, an operation unit 14, and a communication unit 15.

The display unit 13 is configured by, for example, a liquid crystal display or an electroluminescence (EL) display. The display unit 13 displays images on the screen under the control of the controller 11.

The operation unit 14 is, for example, various operation units of a push-button type, a proximity type, and the like. The operation unit 14 detects various operations such as specifying a viewing position and a viewing direction by the user, and outputs them to the controller 11.

The communication unit 15 is configured to be communicable with each server apparatus 20.

The storage unit 12 includes a nonvolatile memory in which various programs and various types of data necessary for the processing of the controller 11 are stored, and a volatile memory used as a work region of the controller 11. Note that the various programs may be read from a portable recording medium such as an optical disc or a semiconductor memory or may be downloaded from the server apparatus 20 on the network.

The controller 11 executes various types of calculations on the basis of various programs stored in the storage unit 12 and collectively controls the units of the terminal apparatus 10.

The controller 11 is implemented by hardware or a combination of hardware and software. The hardware is configured as a part or all of the controller 1. This hardware may be a central processing unit (CPU), a graphics processing unit (GPU), a vision processing unit (VPU), a digital signal processor (DSP), a field programmable gate array (FPGA), an application specific integrated circuit (ASIC), a combination of two or more of those above, or the like. Note that this also applies to the controllers 21 and 31 of the server apparatuses 20.

Note that if the terminal apparatus 10 is a wearable terminal such as an HMD or a mobile terminal such as a smartphone, the terminal apparatus 10 may include various sensors for executing self-position estimation processing. Examples of the various sensors for executing self-position estimation processing include an imaging unit (camera or the like), an inertial sensor (acceleration sensor, angular velocity sensor, or the like), and a global positioning system (GPS).

In this case, the terminal apparatus 10 (controller) estimates a self-position posture by using, for example, simultaneous localization and mapping (SLAM) or the like on the basis of image information from the imaging unit, inertial information (acceleration information, angular velocity information, or the like) from the inertial sensor, position information from the GPS, or the like.

For example, if the terminal apparatus 10 (user) is located at the actual event venue or the like in the real space, the estimated self-position may be used as the viewing position information. Further, if the terminal apparatus 10 (user) is located at the actual event venue or the like in the real space, the estimated self-posture may be used as the viewing direction information.

In this embodiment, roughly speaking, the controller 11 of the terminal apparatus 10 typically executes “viewing position information transmission processing”, “common video information request processing”, “individual video information request processing”, “display processing of image based on common video information”, “display processing of image based on individual video information”, “display processing of image based on small-data-size three-dimensional video”, and the like.

Note that in this embodiment the “small-data-size three-dimensional video” refers to video information generated by reducing the amount of information on three-dimensional videos corresponding to the whole of the event venue or the like in the real space or virtual space (corresponding to all viewing positions within the viewing region 1). This small-data-size three-dimensional video is typically used in the terminal apparatus 10 when a major change in the viewing position, such as going beyond the segment 2, occurs.

[Server Apparatus 20]

Next, the server apparatus 20 will be described. In this embodiment, two types of the server apparatuses 20 are prepared as the server apparatuses 20. The first type is a management server 20a, and the second type is a distribution server 20b. The number of management servers 20a is typically one, and the number of distribution servers 20b is typically multiple.

In the description of this application, if the two types of server apparatuses 20 are not particularly distinguished from each other, they are simply referred to as the server apparatuses 20, and if the two types of server apparatuses 20 are distinguished from each other, they are referred to as the management server 20a and the distribution server 20b. Note that in this embodiment the whole including the management server 20a and the distribution server 20b can also be regarded as a single server apparatus 20.

“Management Server 20a”

First, the management server 20a will be described. FIG. 3 is a block diagram showing the internal configuration of the management server 20a. As shown in FIG. 3, the management server 20a includes a controller 21, a storage unit 22, and a communication unit 23.

The communication unit 23 is configured to be communicable with each terminal apparatus 10 and another server apparatus 20.

The storage unit 22 includes a nonvolatile memory in which various programs and various types of data necessary for the processing of the controller 21 are stored, and a volatile memory used as a work region of the controller 21. Note that the various programs may be read from a portable recording medium such as an optical disc or a semiconductor memory or may be downloaded from another server apparatus on the network.

The controller 21 executes various types of calculations on the basis of various programs stored in the storage unit 22 and collectively controls the units of the management server 20a.

In this embodiment, roughly speaking, the controller 21 of the management server 20a typically executes “grouping processing”, “rendering resource assignment processing”, “distribution server list generation processing”, “common video information generation processing”, “common video information multicast processing”, “individual video information generation processing”, “individual video information unicast processing”, “small-data-size three-dimensional video generation processing”, “small-data-size three-dimensional video multicast processing”, and the like.

Here, in the description of this embodiment, the “rendering resource” means one unit having a processing capability capable of rendering the common video information in multicasting or the individual video information in unicasting. In the single server apparatus 20, the rendering resource may be one or may be multiple.

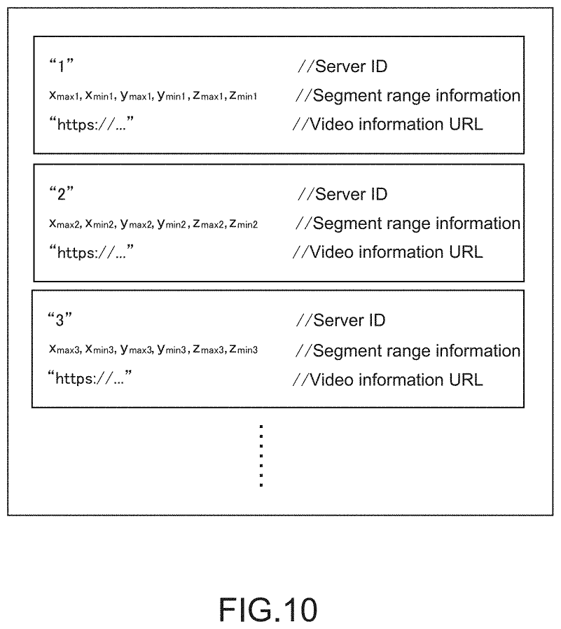

Further, in this embodiment, the “distribution server list” is a list showing to which server apparatus 20 among the plurality of the server apparatuses 20 the terminal apparatus 10 has to request video information in accordance with the self-viewing position (see FIG. 10).

“Distribution Server 20b”

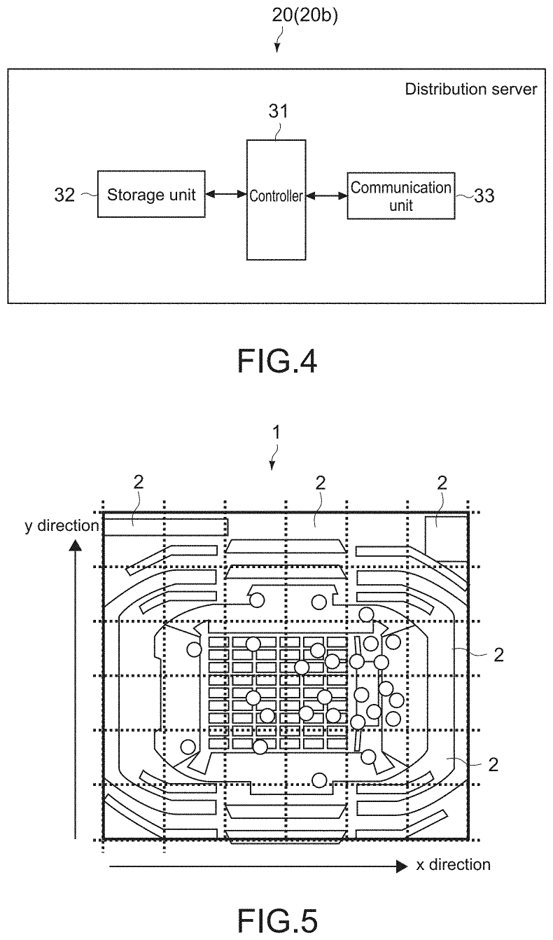

Next, the distribution server 20b will be described. FIG. 4 is a block diagram showing the internal configuration of the distribution server 20b. As shown in FIG. 4, the distribution server 20b includes a controller 31, a storage unit 32, and a communication unit 33.

The distribution server 20b basically has a configuration similar to that of the management server 20a, but the controller 31 performs different processing.

In this embodiment, roughly speaking, the controller 31 of the distribution server 20b typically executes “common video information generation processing”, “common video information multicast processing”, “individual video information generation processing”, “individual video information unicast processing”, and the like.

Here, the management server 20a and the distribution server 20b are different in that the management server 20a executes “grouping processing”, “rendering resource assignment processing”, “distribution server list generation processing”, “small-data-size three-dimensional video generation processing”, and “small-data-size three-dimensional video multicast processing”, whereas the distribution server 20b does not execute those types of processing. In other words, the distribution server 20b basically executes the processing relating to the live distribution of common video information or individual video information in response to the request from the terminal apparatus 10, and does not execute other processing.

Note that in this embodiment the management server 20a has a role as the distribution server 20b, but need not have the function as the distribution server 20b.

### Description on Operation

Next, the processing in each of the terminal apparatus 10 and the server apparatus 20 will be described.

[Terminal Apparatus 10: Viewing Position Information Transmission Processing]

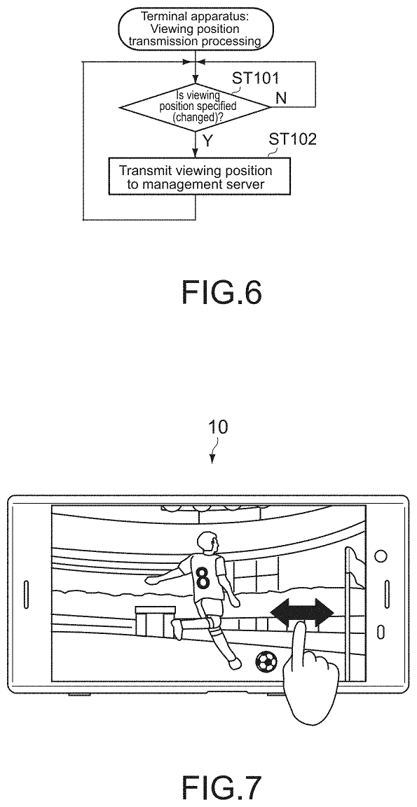

First, the “viewing position information transmission processing” in the terminal apparatus 10 will be described. FIG. 6 is a diagram showing the viewing position information transmission processing in the terminal apparatus 10.

The controller 11 of the terminal apparatus 10 determines whether or not the user has specified (changed) a viewing position within the viewing region 1 (Step 101). If the viewing position has not been specified (changed) (NO in Step 101), the controller 11 of the terminal apparatus 10 returns to Step 101 and determines again whether or not the viewing position has been specified (changed).

Meanwhile, if the user has specified (changed) a viewing position within the viewing region 1, the controller 11 of the terminal apparatus 10 transmits the viewing position information to the management server 20a (Step 102). The controller 11 of the terminal apparatus 10 then returns to Step 101 and determines whether or not the viewing position has been specified (changed).

Here, the method of specifying a viewing position includes, for example, displaying a map, which corresponds to the whole of the event venue or the like in the real space or virtual space, on the display unit 13 of the terminal apparatus 10 by graphical user interfaces (GUIs) and allowing the user to specifying any viewing position. Further, for example, if the user is at the event venue actually, the self-position estimated by the terminal apparatus 10 may be used as information of the viewing position.

Further, the viewing position may be changed after the user specifies the viewing position once. The change of the viewing position may be a major change that goes beyond the segment 2, or may be a minor change that does not go beyond the segment 2.

FIG. 7 shows an example of a state where the user is changing the viewing position. The example shown in FIG. 7 shows a state where the user is changing the viewing position by operating a finger to slide on the screen of a smartphone (terminal apparatus 10) (minor change of the viewing position).

[Management Server 20a: Grouping Processing etc.]

Next, “grouping processing”, “rendering resource assignment processing”, “distribution server list generation processing”, and the like in the management server 20a will be described.

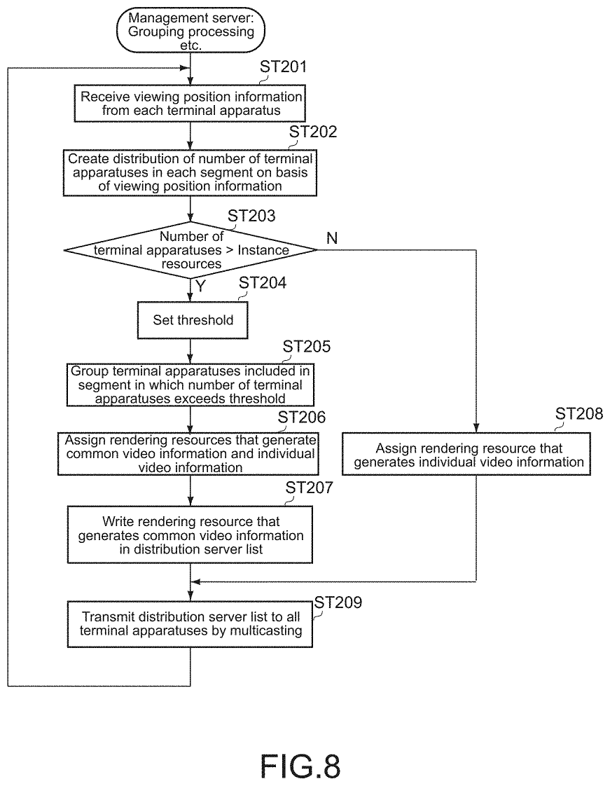

FIG. 8 is a flowchart showing the grouping processing and the like in the management server 20a. First, the controller 21 of the management server 20a receives information of the viewing positions from all the terminal apparatuses 10 that request viewing (Step 201). Next, the controller 21 of the management server 20a creates the distribution of the number of terminal apparatuses in each segment 2 on the basis of the information of the viewing position of each terminal apparatus 10 (Step 202).

Next, the controller 21 of the management server 20a determines whether or not the number of all the terminal apparatuses 10 that request viewing is larger than the total number of rendering resources on the server apparatus 20 (management server 20a, distribution server 20b) side (Step 203).

If the number of terminal apparatuses is larger than the number of rendering resources, the controller 21 of the management server 20a sets a threshold for deciding a segment 2 for grouping the terminal apparatuses 10 (Step 204).

In other words, if the number of terminal apparatuses is larger than the number of rendering resources, individual video information cannot be transmitted to all the terminal apparatuses 10 by unicasting, and thus it is necessary to decide a segment 2 for grouping, and a threshold therefor is set.

In this embodiment, the controller 21 of the management server 20a controls this threshold to be variable on the basis of the distribution of the number of terminal apparatuses in each segment 2 and the number of rendering resources.

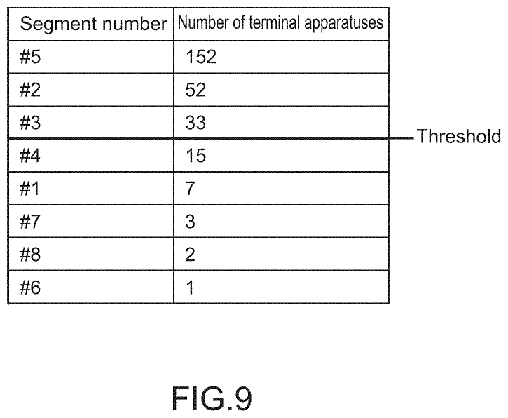

FIG. 9 is a diagram showing the relationship between the distribution of the number of terminal apparatuses in each segment 2 and the threshold. FIG. 9 shows, on the left side, the number for a segment 2, and on the right side, the number of terminal apparatuses each having a viewing position in that segment 2. Further, in FIG. 9, the segments 2 including a larger number of terminal apparatuses are arranged in descending order.

Note that, in the example of FIG. 9, the threshold is set to 15, and the total number of rendering resources on the server apparatus 20 side is assumed to be 40.

In FIG. 9, the total number of terminal apparatuses in five segments 2 of #4, #1, #7, #8, and #6, in which the number of included terminal apparatuses is equal to or smaller than the threshold (15), is 28 (=15+7+3+2+1). If the individual video information is transmitted to those 28 terminal apparatuses 10 by unicasting, the 28 rendering resources are necessary. This is because a single terminal apparatus 10 needs a single rendering resource in the case of unicasting.

Further, in FIG. 9, if the common video information is transmitted by multicasting to the terminal apparatuses 10 grouped for each of the three segments 2 of #5, #2, and #3, in which the number of included terminal apparatuses exceeds the threshold, three rendering resources are necessary. This is because a single segment 2 (a single group of terminal apparatuses 10) needs a single rendering resource in the case of multicasting.

Therefore, if the threshold is set to 15 (i.e., between #3 and #4), 31 (28+3) rendering resources are necessary in total. This value of 31 is a suitable value that does not exceed the number of rendering resources (here, 40).

Here, if the threshold is set to 33 (i.e., between #2 and #3), 63 (61+2) rendering resources are necessary and exceed the total number of rendering resources (here, 40). Further, if the threshold is set to 7 (i.e., between #4 and #1), 17 (13+4) rendering resources are necessary, which does not exceed the total number of rendering resources (here, 40), but unicasting transmission of the individual video information is unnecessarily reduced.

Therefore, in this example, it is suitable that the threshold is set to 15. Such a threshold value is calculated by the controller 21 of the management server 20a.

Note that, as the number of terminal apparatuses that request viewing becomes larger, the threshold value becomes smaller (unicast distribution is reduced). Further, as the number of rendering resources becomes larger, the threshold value becomes larger (unicast distribution is increased).

In the description of this embodiment, the case where the threshold is controlled to be variable has been described, but the threshold may be fixed.

Referring back to FIG. 8, after the threshold is set, the controller 21 of the management server 20a then groups, for each of the segments 2, the terminal apparatuses 10 each having a viewing position within the segment 2, in which the number of terminal apparatuses exceeds the threshold (Step 205). For example, in the example shown in FIG. 9, 152 terminal apparatuses 10 each having a viewing position within the segment 2 of #5 are grouped, and 52 terminal apparatuses 10 each having a viewing position within the segment 2 of #2 are grouped. Further, 33 terminal apparatuses 10 each having a viewing position within the segment 2 of #3 are grouped.

Next, the controller 21 of the management server 20a assigns a rendering resource (server apparatus 20) to handle the generation of common video information for a corresponding group (segment 2), and assigns a rendering resource (server apparatus 20) to handle the generation of individual video information for a corresponding terminal apparatus 10 (Step 206).

Next, a rendering resource (server apparatus 20) that generates common video information for group is written in the distribution server list (Step 207).

FIG. 10 is a diagram showing an example of the distribution server list. As shown in FIG. 10, the distribution server list includes a server ID of the server apparatus 20 (rendering resource) that handles the generation of common video information, segment range information indicating the range of a corresponding segment 2, and a uniform resource locator (URL) of the common video information.

After the information necessary for the distribution server list is written, subsequently, the controller 21 of the management server 20a transmits the distribution server list to all the terminal apparatuses 10 that request viewing by multicasting (Step 209). The controller 21 of the management server 20a then returns to Step 201.

Here, in Step 203, if the number of all the terminal apparatuses 10 that request viewing is equal to or smaller than the total number of rendering resources on the server apparatus 20 side (NO in Step 203), the controller 21 of the management server 20a proceeds to Step 208. In other words, if the individual video information can be transmitted to all the terminal apparatuses 10 by unicasting, the controller 21 of the management server 20a proceeds to Step 208.

In Step 208, the controller 21 of the management server 20a assigns a rendering resource (server apparatus 20) to handle the generation of individual video information for a corresponding terminal apparatus 10.

After Step 208, the controller 21 of the management server 20a transmits the distribution server list to all the terminal apparatuses 10 by multicasting (Step 209), but in this case, a blank distribution server list in which nothing is written is transmitted by multicasting. Subsequently, the controller 21 of the management server 20a returns to Step 201.

[Terminal Apparatus 10: Video Information Request Processing etc.]

Next, “common video information request processing”, “individual video information request processing”, and the like in the terminal apparatus 10 will be described.

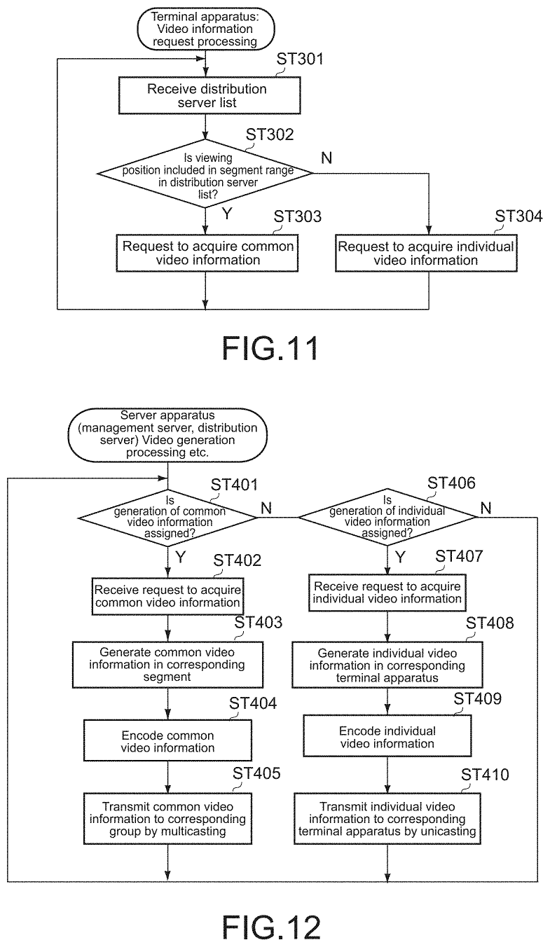

FIG. 11 is a flowchart showing the video information request processing and the like in the terminal apparatus 10. As shown in FIG. 11, the controller 11 of the terminal apparatus 10 receives the distribution server list transmitted by multicasting (Step 301).

Next, the controller 11 of the terminal apparatus 10 determines whether or not the self-viewing position is included in any segment range shown in the distribution server list (Step 302).

If the self-viewing position is included in any segment range (YES in Step 302), the controller 11 of the terminal apparatus 10 transmits a request to acquire the common video information to the server apparatus 20 on the basis of a corresponding server ID and video information URL (Step 303).

Meanwhile, if the self-viewing position is not included in any segment range (NO in Step 302), the controller 11 of the terminal apparatus 10 transmits a request to acquire the individual video information to the server apparatus 20 (Step 304). Note that a request to acquire the individual video information includes the information of the viewing position and the information of the viewing direction.

After transmitting a request to acquire the common or individual video information, the controller 11 of the terminal apparatus 10 returns to Step 301 again.

[Server Apparatus 20: Video Information Generation Processing etc.]

Next, “common video information generation processing”, “individual video information generation processing”, “common video information multicast processing”, “individual video information unicast processing”, and the like in the server apparatuses 20 (management server 20a, distribution server 20b) will be described.

FIG. 12 is a flowchart showing the video information generation processing and the like in the server apparatuses 20. As shown in FIG. 12, the controllers 21 and 31 (rendering resources) of the server apparatuses 20 (management server 20a, distribution server 20b) determine whether or not the generation of the common video information is assigned thereto (Step 401).

If the generation of the common video information is assigned (YES in Step 401), the controllers 21 and 31 of the server apparatuses 20 receive a request to acquire the common video information (Step 402). The controllers 21 and 31 of the server apparatuses 20 then generate the common video information in a corresponding segment 2 from the three-dimensional videos corresponding to the whole of the event venue or the like (Step 403).

Such common video information includes color image information and depth information.

Next, the controllers 21 and 31 of the server apparatuses 20 encode the common video information (Step 404) and transmit the common video information by multicasting to each terminal apparatus 10 included in a corresponding group (Step 405). The controllers 21 and 31 of the server apparatuses 20 then return to Step 401.

In Step 401, if the generation of the common video information is not assigned (NO in Step 401), the controllers 21 and 31 (rendering resources) of the server apparatuses 20 (management server 20a, distribution server 20b) determine whether or not the generation of the individual video information is assigned (Step 406).

If the generation of the individual video information is assigned (YES in Step 406), the controllers 21 and 31 of the server apparatuses 20 receive a request to acquire the individual video information (Step 407). The controllers 21 and 31 of the server apparatuses 20 then generate the individual video information of a corresponding terminal apparatus 10 from the three-dimensional videos corresponding to the whole of the event venue or the like on the basis of the viewing position and viewing direction included in the request to acquire the individual video information (Step 408).

Next, the controllers 21 and 31 of the server apparatuses 20 encode the individual video information (Step 409) and transmit the individual video information to a corresponding terminal apparatus 10 by unicasting (Step 410). The controllers 21 and 31 of the server apparatuses 20 then return to Step 401.

[Management Server 20a: Small-data-size Three-dimensional Video Generation Processing etc.]

Next, “small-data-size three-dimensional video generation processing”, “small-data-size three-dimensional video multicast processing”, and the like in the management server 20a will be described.

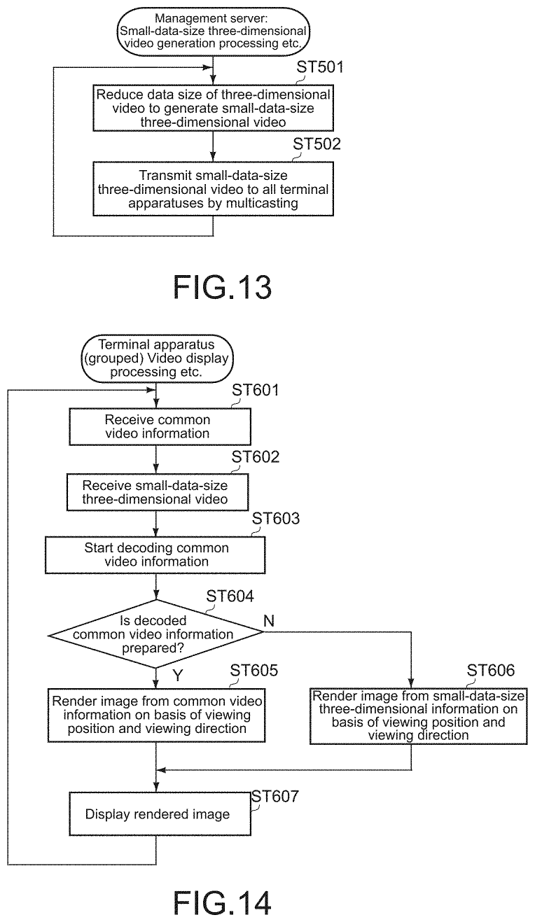

FIG. 13 is a flowchart showing the small-data-size three-dimensional video generation processing and the like in the management server 20a. First, the controller 21 of the management server 20a reduces the data size of the three-dimensional video corresponding to the whole of the event venue or the like and generates a small-data-size three-dimensional video (Step 501). The controller 21 of the management server 20a transmits the small-data-size three-dimensional video to all the terminal apparatuses 10 by multicasting (Step 502) and then returns to Step 501.

Here, the three-dimensional video includes mesh (geometry information) and texture (image information). For example, the controller 21 of the management server 20a may reduce the number of meshes and the texture resolution in the three-dimensional video to generate a small-data-size three-dimensional video.

When a three-dimensional small-data-size video is generated, the controller 21 of the management server 20a may change at least one of the number of meshes or the texture resolution for each object included in the three-dimensional small-data-size video.

For example, a higher number of meshes and higher texture resolution may be set for objects viewed by a larger number of users than those of objects viewed by a smaller number of users on the basis of the information of the viewing position and viewing direction of each terminal apparatus 10.

Further, for example, a higher number of meshes and higher texture resolution may be set for dynamic objects than those of static objects.

Further, the controller 21 of the management server 20a may be capable of transmitting the small-data-size three-dimensional video in units of object, for each object included in the small-data-size three-dimensional video. In this case, the controller 21 of the management server 20a may change, for each of the objects, the frequency of transmission of the small-data-size three-dimensional video in units of object.

For example, a higher frequency of transmission in units of object may be set for objects viewed by a larger number of users than that of objects viewed by a smaller number of users on the basis of the information of the viewing position and viewing direction of each terminal apparatus 10.

Further, for example, a higher frequency of transmission in units of object may be set for dynamic objects than that of static objects.

[Terminal Apparatus 10 (Grouped): Video Display Processing etc.]

Next, “display processing of image based on common video information”, “display processing of image based on small-data-size three-dimensional video”, and the like in the grouped terminal apparatuses 10 will be described.

FIG. 14 is a flowchart showing image display processing and the like in the grouped terminal apparatuses 10. First, the terminal apparatus 10 receives the common video information transmitted by multicasting to each terminal apparatus 10 included in a corresponding group (Step 601).

Next, the terminal apparatus 10 receives the small-data-size three-dimensional video transmitted by multicasting to all the terminal apparatuses 10 (Step 602). Next, the controller 11 of the terminal apparatus 10 starts decoding the common video information (Step 603).

Next, the controller 11 of the terminal apparatus 10 determines whether or not the decoded common video information has been prepared (Step 604).

If the decoded common video information has been prepared (YES in Step 604), the controller 11 of the terminal apparatus 10 proceeds to Step 605. In Step 605, the controller 11 of the terminal apparatus 10 renders an image from the decoded common video information on the basis of the viewing position and the viewing direction (corrects image to be rendered). The controller 11 of the terminal apparatus 10 then displays the rendered image on the screen of the display unit 13 (Step 607) and returns to Step 601.

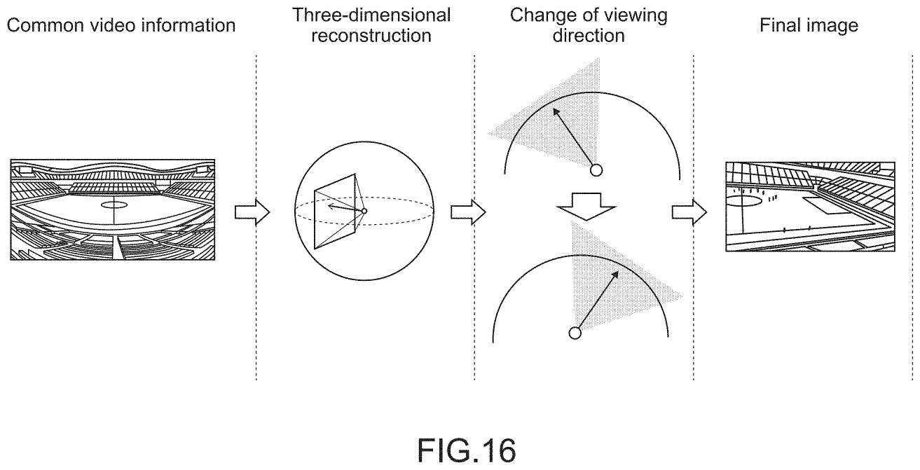

FIG. 16 is a diagram showing a state where an image is rendered from the common video information. As shown in the left part of FIG. 16, the common video information has a wider angle than the display angle of view of the terminal apparatus 10. The controller 11 of the terminal apparatus 10 maps such common video information on a three-dimensional model (performs three-dimensional reconstruction) and performs projection in accordance with the requested viewing direction (see the arrow) and display angle of view to generate a final image.

Note that the viewing direction may be changed, but the controller 11 of the terminal apparatus 10 can generate an image having a new viewing direction by using the same decoded common video information, so that it is possible to display an image at a low delay when the viewing direction is changed.

Here, in the common video information, the viewing position is temporarily set at the center position of the segment 2, but the viewing position of each terminal apparatus 10 is not limited to the center position of the segment 2. Further, the viewing position may move within the segment 2. Therefore, in such a case, it is necessary to change (correct) not only the viewing direction but also the viewing position.

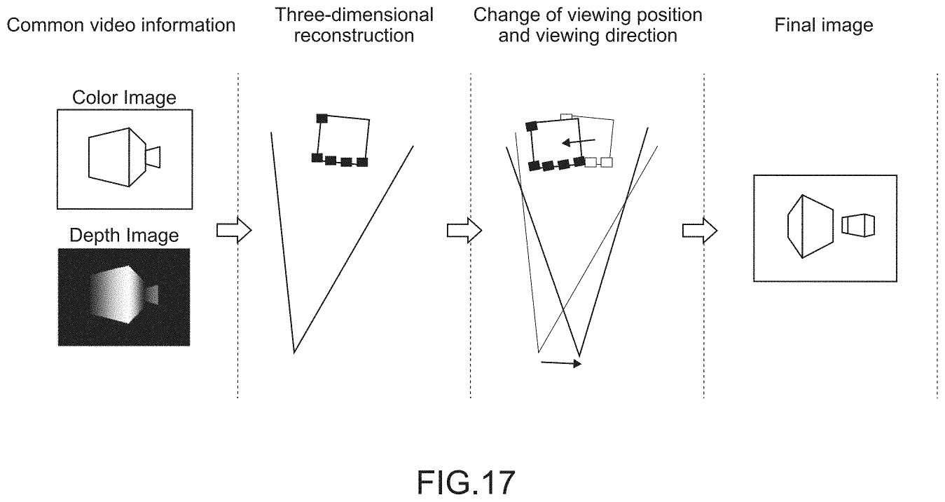

FIG. 17 is a diagram showing a state where the viewing position is moved to the requested viewing position and the viewing direction is changed to the requested viewing direction.

As shown in the left part of FIG. 17, the common video information includes color image information and depth information. The controller 11 of the terminal apparatus 10 performs three-dimensional reconstruction for each pixel by using the depth information of each pixel. The controller 11 of the terminal apparatus 10 then performs projection in accordance with the requested viewing position, viewing direction, and display angle of view to generate a final image.

Note that the controller 11 of the terminal apparatus 10 can generate an image having new viewing position and viewing direction by using the same decoded common video information, so that it is possible to display an image at a low delay when the viewing position and the viewing direction are changed.

Referring back to FIG. 14, in Step 604, if the decoded common video information has not been prepared (NO in Step 604), the controller 11 of the terminal apparatus 10 proceeds to Step 606.

Here, for example, it is assumed that the user greatly changes the viewing position and that the viewing position is moved from the original segment 2 to a position within another segment 2. In such a case, for example, the reception of the individual video information by unicasting may be switched to the reception of the common video information. Further, in such a case, for example, the reception of the common video in the original segment 2 may be switched to the reception of the common video in another segment 2.

Immediately after such switching, the decoded common video information may be unprepared. Therefore, in such a case, if no countermeasures are taken, there arises a problem that the switching to the image to be displayed is not smoothly performed.

Therefore, if the decoded common video information has not been prepared (if the viewing position goes beyond the segment 2), the controller 11 of the terminal apparatus 10 renders an image from the small-data-size three-dimensional video on the basis of the requested viewing position and viewing direction (Step 606). The controller 11 of the terminal apparatus 10 then displays the rendered image on the screen of the display unit 13 and returns to Step 601.

Use of the small-data-size three-dimensional video in such a manner makes it possible to smoothly switch to the image to be displayed in the case where the viewing position is greatly changed and moves from the original segment 2 to another segment 2.

[Terminal Apparatus 10 (Not Grouped): Video Display Processing etc.]

Next, “display processing of image based on individual video information”, “display processing of image based on small-data-size three-dimensional video”, and the like in the terminal apparatus 10 not grouped will be described.

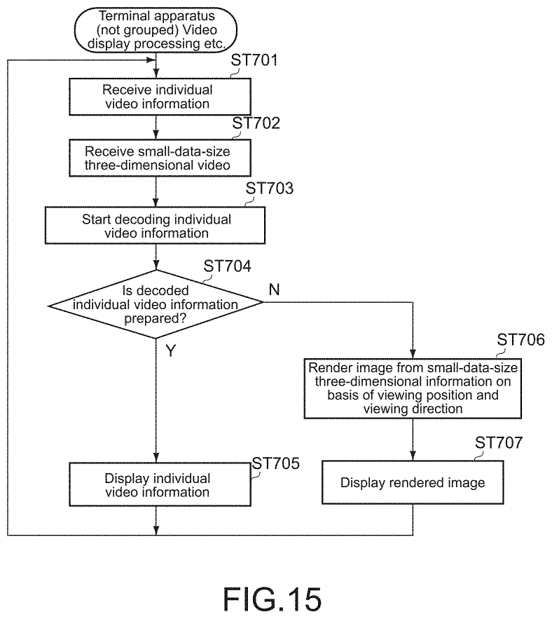

FIG. 15 is a flowchart showing image display processing and the like in the terminal apparatus 10 not grouped. First, the terminal apparatus 10 receives the individual video information transmitted to itself by unicasting (Step 701). Note that such individual video information is video information, which is different from the common video information and in which the viewing position and viewing direction requested in that terminal apparatus 10 are already reflected.

Next, the terminal apparatus 10 receives the small-data-size three-dimensional video transmitted by multicasting to all the terminal apparatuses 10 (Step 702). Next, the controller 11 of the terminal apparatus 10 starts decoding the individual video information (Step 703).

Next, the controller 11 of the terminal apparatus 10 determines whether or not the decoded individual video information has been prepared (Step 604).

If the decoded individual video information has been prepared (YES in Step 704), the controller 11 of the terminal apparatus 10 displays that individual video information on the screen of the display unit 13 (Step 705) and returns to Step 701.

Meanwhile, if the decoded common video information has not been prepared (NO in Step 704), the controller 11 of the terminal apparatus 10 proceeds to Step 706.

Here, for example, it is assumed that the user greatly changes the viewing position and that the viewing position is moved from the original segment 2 to a position within another segment 2. In this case, for example, the reception of the common video information by unicasting may be switched to the reception of the individual video information. Immediately after such switching, the decoded common video information may be unprepared.

Therefore, if the decoded common video information has not been prepared (if the viewing position goes beyond the segment 2), the controller 11 of the terminal apparatus 10 renders an image from the small-data-size three-dimensional video on the basis of the requested viewing position and viewing direction (Step 706). The controller 11 of the terminal apparatus 10 then displays the rendered image on the screen of the display unit 13 (Step 707) and returns to Step 701.

Use of the small-data-size three-dimensional video in such a manner makes it possible to smoothly switch to the image to be displayed in the case where the viewing position is greatly changed and moves from the original segment 2 to another segment 2.

### Actions etc.

As described above, in this embodiment, the server apparatus 20 side executes the following processing under predetermined conditions: on the basis of the viewing position information in each terminal apparatus 10 within the viewing region 1 including the plurality of segments 2, the terminal apparatuses 10 each having a viewing position in the same segment 2 are grouped; and common video information is transmitted to the grouped terminal apparatuses 10 by multicasting.

This makes it possible to reduce the processing load on the server apparatus 20 side, and a necessary network band is reduced. Further, for example, it is possible for the server side to perform rendering for many terminal apparatuses 10, even in applications where computing resources are limited as compared to public cloud such as edge cloud in the local 5G network.

Further, in this embodiment, the threshold for deciding the segment 2 for grouping is controlled to be variable. This makes it possible to dynamically change the threshold into a suitable value.

Further, in this embodiment, the terminal apparatus 10 side (grouped) can promptly cope with a minor change of the viewing position or a change of the viewing direction (see FIGS. 16 and 17).

Further, in this embodiment, use of the small-data-size three-dimensional video makes it possible for the terminal apparatus 10 side to smoothly display an image at a new viewing position when a major change of the viewing position beyond the segment 2 occurs.

### VARIOUS MODIFIED EXAMPLES

Next, how the information processing system 100 of this embodiment is specifically used will be described.

1. Watching Sports at Stadium in Real Space

For example, a user freely selects a viewing position that cannot be seen from the spectator stand to watch sports live while enjoying a sense of reality in the spectator stand. The user may be in the spectator stand while carrying or wearing the terminal apparatus 10 or may be in a place other than the stadium.

2. Watching E-sports Tournaments in Real Space

For example, a user can watch the competitions of top players live from any place the user likes in a game field. The user may be in the game field while carrying or wearing the terminal apparatus 10 or may be in a place other than the game field.

3. Watching Singer's Concert Performed in Virtual Space

For example, a user can watch a singer's concert live from any place the user likes, such as the spectator stand in a virtual space or on the stage where the singer is located. The user may be in any place in the real world.

4. Watching V-Tuber Concert Performed in Virtual Space

For example, a user can watch a V-Tuber concert live from any place the user likes, such as the spectator stand in a virtual space or on the stage where the V-Tuber is located. The user may be in any place in the real world.

5. Viewing Physician's Surgery in Operating Room In Real Space

For example, a user (e.g., resident physician) can view the top-level physician's surgery live from any position and angle the user likes. The user basically performs viewing in a place other than the operating room.

6. Viewing Live Broadcast Programs Transmitted from Studio in Virtual Space For example, a user can view live broadcast programs from any position and angle the user likes within a studio in a virtual space. The user may be in any place in the real world.

The present technology can also have the following configurations.

(1) A server apparatus, including

a controller that groups terminal apparatuses each having a viewing position within an identical segment on the basis of viewing position information of each terminal apparatus within a viewing region including a plurality of segments, and transmits common video information to each of the grouped terminal apparatuses by multicasting.

(2) The server apparatus according to (1), in which

the controller determines a segment, in which the number of the terminal apparatuses exceeds a predetermined threshold, as a segment for the grouping.

(3) The server apparatus according to (2), in which

the controller controls the threshold to be variable.

(4) The server apparatus according to (3), in which

the controller controls the threshold to be variable on the basis of a distribution of the number of the terminal apparatuses in each segment.

(5) The server apparatus according to (3) or (4), in which

the server apparatus includes a plurality of rendering resources, and

the controller controls the threshold to be variable on the basis the number of the rendering resources.

(6) The server apparatus according to (1), in which

the common video information has a wider angle than a display angle of view of a display unit of each of the terminal apparatuses, and

each of the grouped terminal apparatuses renders an image to be displayed from the common video information on the basis of a viewing direction and a display angle of view, which are requested in each terminal apparatus.

(7) The server apparatus according to (6), in which

each of the grouped terminal apparatuses renders an image to be displayed from the common video information on the basis of the viewing position requested in each terminal apparatus.

(8) The server apparatus according to (7), in which

the common video information includes depth information of an object within a video, and

each of the grouped terminal apparatuses renders the image on the basis of the depth information.

(9) The server apparatus according to any one of (1) to (8), in which

the controller transmits individual video information by unicasting to each of terminal apparatuses not grouped.

(10) The server apparatus according to (9), in which

the controller reduces a data size of a three-dimensional video corresponding to all the viewing positions within the viewing region to generate a small-data-size three-dimensional video, and transmits the small-data-size three-dimensional video to all the terminal apparatuses by multicasting.

(11) The server apparatus according to (10), in which

each of the terminal apparatuses renders an image to be displayed on the basis of the small-data-size three-dimensional video when the viewing position requested in each terminal apparatus moves beyond the segment.

(12) The server apparatus according to (10) or (11), in which

the small-data-size three-dimensional video includes a mesh in an object within the small-data-size three-dimensional video, and

the controller changes the number of meshes in the mesh for each object.

(13) The server apparatus according to any one of (10) to (12), in which

the small-data-size three-dimensional video includes a texture in an object within the small-data-size three-dimensional video, and

the controller changes resolution of the texture for each object.

(14) The server apparatus according to any one of (10) to (13), in which

the controller is capable of transmitting the small-data-size three-dimensional video in units of object, for each object included in the small-data-size three-dimensional video, and changes a frequency of transmission of the small-data-size three-dimensional video in units of object, for each object.

(15) A terminal apparatus, including

a controller that
receives common video information from a server apparatus that groups terminal apparatuses each having a viewing position within an identical segment on the basis of viewing position information of each terminal apparatus within a viewing region including a plurality of segments, and transmits the common video information to each of the grouped terminal apparatuses by multicasting, and
renders an image to be displayed on the basis of the received common video information.
   (16) An information processing system, including:

a server apparatus that groups terminal apparatuses each having a viewing position within an identical segment on the basis of viewing position information of each terminal apparatus within a viewing region including a plurality of segments, and transmits common video information to each of the grouped terminal apparatuses by multicasting; and

receives the common video information and renders an image to be displayed on the basis of the received common video information.

(17) An information processing method, including:

grouping terminal apparatuses each having a viewing position within an identical segment on the basis of viewing position information of each terminal apparatus within a viewing region including a plurality of segments; and

transmitting common video information to each of the grouped terminal apparatuses by multicasting.

### REFERENCE SIGNS LIST

10 terminal apparatus
20 server apparatus
20a management server
20b distribution server
100 information processing system

1. A server apparatus, comprising
a controller that groups terminal apparatuses each having a viewing position within an identical segment on a basis of viewing position information of each terminal apparatus within a viewing region including a plurality of segments, and transmits common video information to each of the grouped terminal apparatuses by multicasting.

2. The server apparatus according to claim 1, wherein
the controller determines a segment, in which the number of the terminal apparatuses exceeds a predetermined threshold, as a segment for the grouping.

3. The server apparatus according to claim 2, wherein the controller controls the threshold to be variable.

4. The server apparatus according to claim 1, wherein
the common video information has a wider angle than a display angle of view of a display unit of each of the terminal apparatuses, and
each of the grouped terminal apparatuses renders an image to be displayed from the common video information on a basis of a viewing direction and a display angle of view, which are requested in each terminal apparatus.

5. The server apparatus according to claim 4, wherein
each of the grouped terminal apparatuses renders an image to be displayed from the common video information on a basis of the viewing position requested in each terminal apparatus.

6. The server apparatus according to claim 5, wherein
the common video information includes depth information of an object within a video, and
each of the grouped terminal apparatuses renders the image on a basis of the depth information.

7. The server apparatus according to claim 1, wherein
the controller transmits individual video information by unicasting to each of terminal apparatuses not grouped.

8. The server apparatus according to claim 7, wherein
the controller reduces a data size of a three-dimensional video corresponding to all the viewing positions within the viewing region to generate a small-data-size three-dimensional video, and transmits the small-data-size three-dimensional video to all the terminal apparatuses by multicasting.

9. The server apparatus according to claim 8, wherein
each of the terminal apparatuses renders an image to be displayed on a basis of the small-data-size three-dimensional video when the viewing position requested in each terminal apparatus moves beyond the segment.

10. The server apparatus according to claim 8, wherein
the small-data-size three-dimensional video includes a mesh in an object within the small-data-size three-dimensional video, and
the controller changes the number of meshes in the mesh for each object.

11. The server apparatus according to claim 8, wherein
the small-data-size three-dimensional video includes a texture in an object within the small-data-size three-dimensional video, and
the controller changes resolution of the texture for each object.

12. The server apparatus according to claim 8, wherein
the controller is capable of transmitting the small-data-size three-dimensional video in units of object, for each object included in the small-data-size three-dimensional video, and changes a frequency of transmission of the small-data-size three-dimensional video in units of object, for each object.

13. A terminal apparatus, comprising
a controller that
receives common video information from a server apparatus that groups terminal apparatuses each having a viewing position within an identical segment on a basis of viewing position information of each terminal apparatus within a viewing region including a plurality of segments, and transmits the common video information to each of the grouped terminal apparatuses by multicasting, and
renders an image to be displayed on a basis of the received common video information.

14. An information processing system, comprising:
a server apparatus that groups terminal apparatuses each having a viewing position within an identical segment on a basis of viewing position information of each terminal apparatus within a viewing region including a plurality of segments, and transmits common video information to each of the grouped terminal apparatuses by multicasting; and
receives the common video information and renders an image to be displayed on a basis of the received common video information.

15. An information processing method, comprising:
grouping terminal apparatuses each having a viewing position within an identical segment on a basis of viewing position information of each terminal apparatus within a viewing region including a plurality of segments; and
transmitting common video information to each of the grouped terminal apparatuses by multicasting.
